(19) United States
(12) Patent Application Publication
(10) Pub. No.: US 2014/0052431 A1
(43) Pub. Date: Feb. 20, 2014

(54) SUPPORTING PROACTIVE DECISION-MAKING IN EVENT-DRIVEN APPLICATIONS

(71) Applicants: Yagil Engel, (US); Opher Etzion, Haifa (IL); Zohar Feldman, Haifa (IL); Guy Sharon, Rehovot (IL)

(72) Inventors: Yagil Engel, (US); Opher Etzion, Haifa (IL); Zohar Feldman, Haifa (IL); Guy Sharon, Rehovot (IL)

(73) Assignee: INTERNATIONAL BUSINESS MACHINES CORPORATION, Armonk, NY (US)

(21) Appl. No.: 13/589,175

(22) Filed: Aug. 20, 2012

(51) Int. Cl. G06F 9/44

(52) U.S. Cl. 703/21

(57) ABSTRACT

A computerized method of adapting an event management framework comprising providing an event processing network (EPN) which models processing of a plurality of incoming events by the event management framework, providing at least one goal specifying a target value of at least one measurable attribute of the event management framework, performing a plurality of simulations on the EPN, each simulation of the processing of the plurality of incoming events according to a different set of a plurality of control values defining a behavioral pattern of at least one event processing agent of the EPN, selecting a control values set from the plurality of control values sets according to a match between an outcome of the plurality of simulations and the at least one target value, and adapting the event management framework according to the selected control values set.

### BACKGROUND

The present invention, in some embodiments thereof, relates to event processing frameworks and, more specifically, but not exclusively, to proactive decision making in event processing applications.

Events may be considered as a change of state within physical or logical conditions in a technical framework or system. Event generation is typically accompanied by providing information such as the essence of the change, a timestamp and a topology mark which may be used to define an order of and location of the event occurrence.

Functionality of event processing frameworks may be modeled by event processing networks (EPNs). An EPN has one or more event processing agents each carrying out one or more event processing rules to process a plurality of incoming instances of one or more event types.

Reactive event processing applications include monitoring events happening within a system or an organization in real time, identifying meaningful events and complex occurrences, analyzing their impact, and taking actions according to the analysis. Proactive event processing refers to the ability to make optimized decisions, taking into account knowledge and prediction about the future: Proactive event processing may include applying prediction and automated decision-making technologies to mitigate or eliminate undesired future events, or identify and take advantage of future opportunities.

Proactive event processing applications have been developed particularly in the information technology (IT) infrastructure and management domain, for example in the fields of security, wireless and/or mobile network routing and caching. The development of such event processing applications from scratch entails hard-coded integration of multiple tools from different disciplines; the event processing applications developed are challenging to configure, typically requiring that users have diversified skills and in depth understanding of the application.

### SUMMARY

According to an aspect of some embodiments of the present invention there is provided a computerized method of adapting an event management framework. The method comprises providing an event processing network (EPN) which models processing of a plurality of incoming events by the event management framework, providing at least one goal specifying a target value of at least one measurable attribute of the event management framework, performing a plurality of simulations of the processing of the plurality of incoming events by the EPN where in each simulation a set of a plurality of control value sets is simulated on the EPN, each control value defines a behavioral pattern of at least one event processing agent of said EPN, selecting a control values set from the plurality of control values sets according to a match between an outcome of the plurality of simulations and the at least one target value, and adapting the event management framework according to the selected control values set.

According to an aspect of some embodiments of the present invention there is provided a system for adapting an event management framework. The system comprises a processor; an interface module which receives an event processing network (EPN) which models processing of a plurality of incoming events by the event management framework, at least one goal specifying a target value of at least one measurable attribute of the event management framework, and a plurality of control value sets each comprising at least one control value defining a behavioral pattern of at least one event processing agent of the EPN; an event processing simulation module which performs a plurality of simulations of the processing of a plurality of incoming events by the EPN where in each simulation a different set of a plurality of control value sets is simulated on the EPN; and a control values set selection module which selects a control values set from the plurality of control values sets according a match between an outcome of the plurality of simulations and the target value.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method for adapting an event management framework, according to some embodiments of the present invention;

FIG. 2 is a relational view of software and hardware components of a system for adapting an event management framework, according to some embodiments of the present invention;

FIG. 3 is a diagram illustrating the input and output of an incoming events simulation module and a scoring module, according to some embodiments of the present invention; and

FIG. 4 is an exemplary embodiment of an adaptation of a call center event processing framework, according to some embodiments of the present invention.

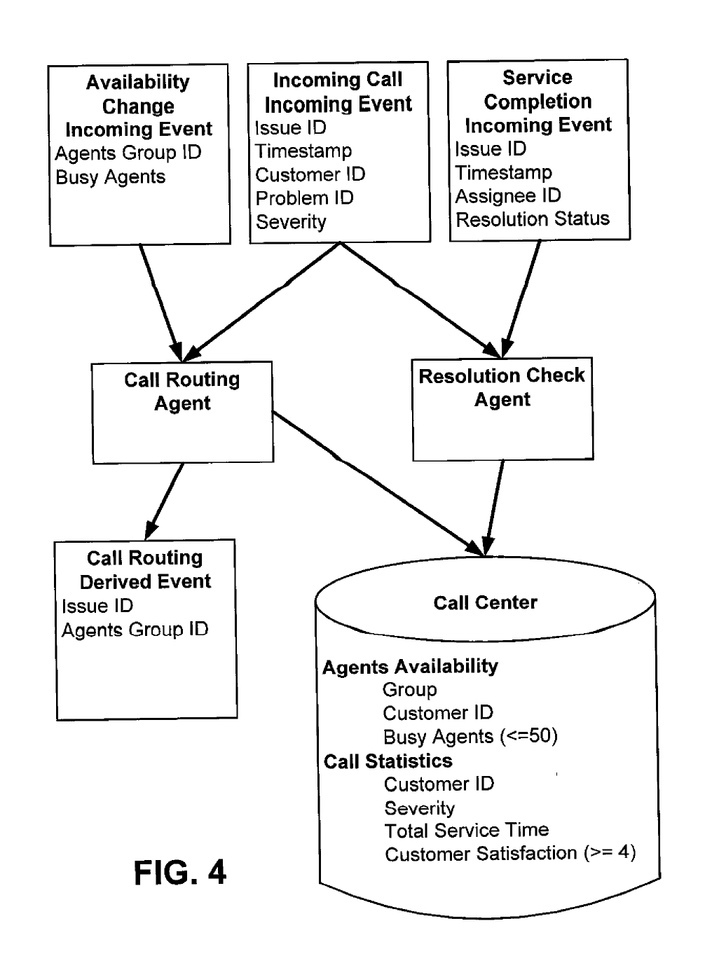

### DETAILED DESCRIPTION

The present invention, in some embodiments thereof, relates to event processing frameworks and, more specifically, but not exclusively, to proactive decision making in event processing frameworks.

According to some embodiments of the present invention, there are provided methods and systems of adapting an event management framework, modeled by an EPN, to meet or to improve toward one or more goals specifying target values for one or more measurable attributes. The measurable attributes are used by the EPN to assess effectiveness and/or functionality of the event processing framework. Adaptation is based on setting control values of control variables which define behavioral patterns of event processing rules.

For example, a control variable in an EPN which models a servicing framework may be a selection of an available service station to attend the call. Event processing rules may process incoming service call events to assign a suitable service station to handle the incoming event. The number of available service stations controls the number of incoming events which may be processed simultaneously by the servicing platform.

The setting, for example the selection, of the control values is made according to the outcome(s) of multiple simulations of a predictive process indicating occurrences of incoming events. Events may be of different types, and event processing rules may be configured to process incoming events each according to its event type.

Each simulation produces a state values set. Each of the state values within a state value set corresponds with each of the measurable attributes. Measurable attributes are used in an EPN to reflect momentary and ongoing statuses within the event processing framework. An exemplary measurable attributes in an EPN which models a servicing framework may represent the number of busy service stations in a certain point in time. In the EPN, each incoming event may momentarily raise or lower a state value assigned to a measurable attribute representing the number of busy service stations in the EPN. The effect of the incoming event on the state value assigned to a measurable attribute is determined according to the event type and the event processing rules.

Control values for control variables are selected according to the multiple simulations. The compliance of control values' respective resulting state values in each of the simulations is assessed according to the one or more goals. Each goal specifies a target value of at least one measurable attribute in the EPN. An exemplary goal in an EPN which models a servicing framework may refer to service timing, for example the goal may be that no incoming events wait for a service station longer than a specified quantum which is measured by a measurable attribute in the EPN.

In some embodiments, control values may also be selected according to additional constraints specifying relations between different control variables and/or measurable attributes. Constraints specifying a conditional relation between two or more control variables will be referred to herein as control constraints. Constraints specifying a conditional relation between one or more control variable and one or more measurable attribute will be referred to herein as state constraints.

Some embodiments of the present invention extend event processing modeling and annotations to express goals, control variables and constraints. These embodiments may enable selection of control values for the control variables, optionally in real time, such that the expressed goals and constraints of the EPN are met. The selection of control values is based on the event-processing conceptual model and multiple simulation run-time results, by automatically constructing a generative Markov decision computation model in real-time and solving the computation model using appropriate reinforcement learning algorithms.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

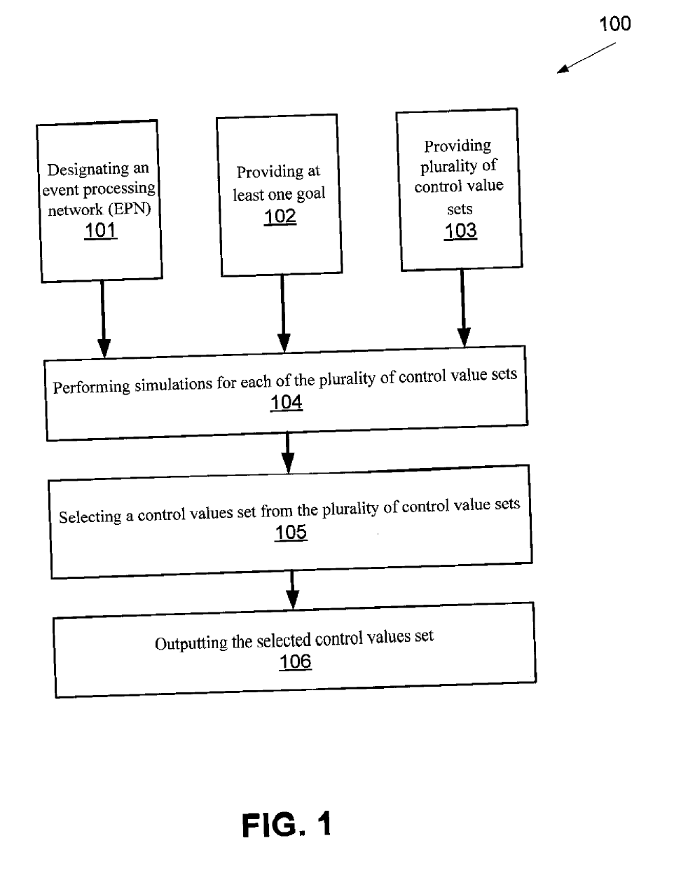

Reference is now made to FIG. 1, which is a flowchart of a method 100 for adapting an event management framework to meet one or more user defined goals or improve towards meeting these goals, according to some embodiments of the present invention. The method 100 identifies a set of control values for control variables which define behavioral patterns of event processing rules of one or more event processing agents of an EPN modeling incoming event processing. This adaptation includes EPN modeling enhancement(s) which enable expression of goals, constraints, and control variables which guide the behavioral patterns of event processing rules in different decision points. The set of control values for the control variables is selected according to a plurality of simulations, as will be described hereinbelow.

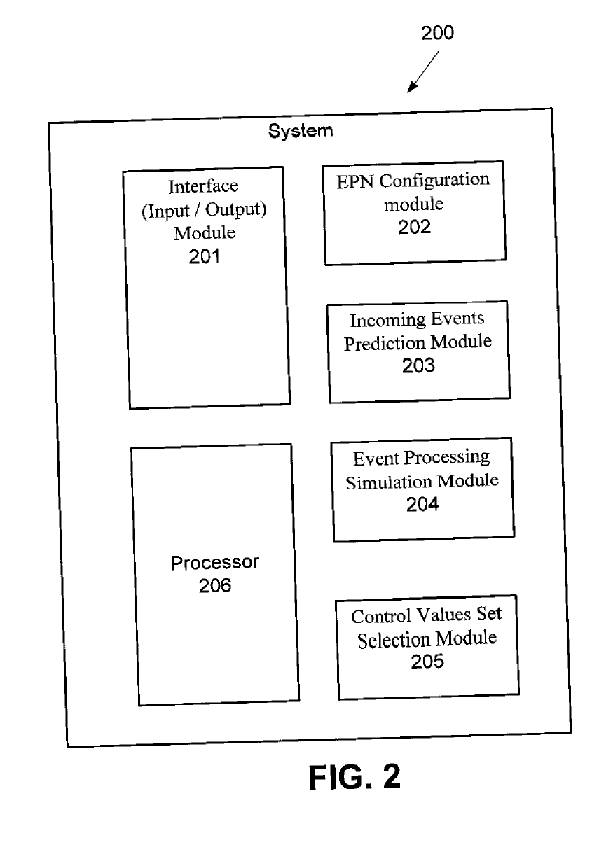

Reference is also made to FIG. 2, which is a relational view of software and hardware components of a system 200 for adapting an event management framework, according to some embodiments of the present invention.

The system 200 includes an interface serving as an input and/or output module 201, an EPN configuration module 202, an incoming events prediction module 203, an event processing simulation module 204, a control values set selection module 205, and a processor 206. For brevity, it should be noted that computing functions described herein may be performed using the processor 206.

System 200 extends the EPN by linking it with proactive decision making concepts such as goals, control variables, constraints and states. Usage of the system enables customization of existing event processing frameworks according to the proactive decision making concepts supplied by a user.

The method 100 and system 200 may be implemented as an EPN platform, an add-on to an existing EPN platform, and/or as a software as a service (SaaS) which provides services for users via client terminals.

As shown at numeral 101 of FIG. 1, first, the interface 201 acquires, for example receives and/or accesses, an EPN representing the event processing framework. The EPN includes one or more event processing agents, each agent carrying out one or more event processing rules to process a plurality of incoming event instances of one or more event types. The EPN may be received as a file, indicated by a link to a file, scanned from a document, and/or the like.

As shown at numeral 102 of FIG. 1, the interface 201 also acquires at least one goal denoting an objective to be satisfied, improved or optimized within the event processing framework. A goal may specify a target value or target range which refers to any one or more measurable attributes within the event processing framework. Measurable attributes may refer to states of the global framework or a specific event processing agent, incoming events or the like.

Optionally, the interface 201 may also acquire one or more constraints, each specifying a conditional relation between different control variables or between a control variable and a measurable attribute within the EPN. Types of constraints may include control constraints which define a conditional relation between at least two control variables, or state constraints which define a conditional relation between one or more of the control variables and one or more of the of measurable attributes within the EPN.

Constraints may not be enforced at all times, for example may include provisions indicating when the constraints should be enforced. Provisions may relate to the time of day, event type, and/or any other attribute relevant to the event processing framework.

As shown in numeral 103 of FIG. 1, the interface 201 acquires, for example receives and/or accesses, a plurality of control value sets. Each control value set includes control values for each of corresponding control variables. In some embodiments, a user may interactively dictate control value sets, or alternatively an automated generator of control value sets according to the EPN may be used. The interface may access a file or files which define control value sets to be used in simulations. The provided control value sets are used by an EPN configuration module 202 to configure the control variables used by event processing rules to simulate processing of incoming events by the one or more event processing agents employed by the EPN.

An EPN configuration module 202 may configure the control variables multiple times, for example upon request of an event processing agent, or alternatively once in each rollout, for example when a control variable refers to a global state.

As shown in numeral 104 of FIG. 1, an event processing simulation module 204 performs multiple simulations using each of the provided control value sets. Each control value in each of the control value sets defines a behavioral pattern of at least one event processing agent of the EPN.

An incoming events prediction module 203 performs statistical analysis of incoming events and produces a forecast predicting future occurrences of such events. The forecast may include for each type of event, future occurrences of event instances along with their related attributes. The event attributes may be deterministic or stochastic, and in the latter case, event attributes may have a joint distribution.

Forecasting of time and volume of event occurrences by the incoming events prediction module 203 according to event types may include methods known in the art such as but not limited to time series and/or distribution fitting. Attribute values for the events may also be forecasted using joint distribution fitting, temporal probabilistic dependencies and causality between streams of events also referred to as correlation, or the like.

The forecast results are future events to be injected into the event processing simulation module 204. For each control variables set, the results of the simulations may be recorded. For example, assigned values of measurable attributes in the EPN or EPN global states may be recorded as reference for the decision making process.

In some embodiments of the present invention, an optimization algorithm may be employed to generate control value sets according to simulation results, such that the control value sets meet the specified goals and constraints. The EPN configuration module 202 may use such automatically generated control value sets to configure control variables in the EPN for future simulations.

As shown in numeral 105 of FIG. 1, a control values selection module 205 selects a control values set from the provided control value sets. Selection may be according to previously recorded assigned values of measurable attributes or global states in the EPN. The selected control variable set generates assigned values which satisfy the one or more goals provided to the system. Optimization methods may be used to determine which control values set is substantially optimal or near-optimal for satisfying the specified goals. The selection of the control values set is according to a match between outcomes of the simulations and the target values specified within the goals and constraints. The selected set of control values is used for adapting the event management framework according the specified goals and constraints.

The control values selection module 205 may use a plurality of optimization model types, for example and without limitation a dynamic Markov decision making model. An approach such as Q-learning may be utilized to select an optimal or near optimal control values set according to which the EPN policy will be configured. Q-learning methods operate by estimating the value of state-action pairs Q(s,a) representing the value of executing action a in state s. This may be based on the equation:

$$Q ( s , a ) = R ( s , a ) + {\sum }_{{s}^{′}} T ( s , a , {s}^{′} ) {max}_{{a}^{′}} Q ( {s}^{′} , {a}^{′} )$$

### Where:

R(s,a) denotes an instant reward obtained by taking action α at state s;
T(s,a,s′) denotes a probability of transitioning to state s′ given that action α was taken in state s; and

$${max}_{{a}^{′}} Q ( {s}^{′} , {a}^{′} )$$

denotes a value of the best action available in state s.

Least-square policy iteration (LSPI) is an example of such Q-learning method, wherein the value of state-action pairs are estimated from numerous observations quadruples of state, action, instant reward, and next state. These observations can be obtained from historical records, live interaction with the environment, or by simulation. In each iteration of LSPI, the Q-values are updated by observations of the aforementioned form, where the actions in each state are selected to maximize the Q-value from the previous iteration, for that specific state.

Additionally and alternatively, other approaches such as but not limited to Monte-Carlo learning may be employed. In Monte-Carlo learning, the value of state-action pairs is estimated from simulating action sequences. Each action sequence may be repeatedly simulated numerous times.

In some embodiments, forecasting of time and volume of event occurrences by the incoming events prediction module 203 is performed based on statistical analysis of incoming events in real time on an active EPN. In such embodiments, the control values set selected by the control values selection module 205 may be used to configure the EPN in real time, as the selected control values set relates to real incoming events which occurred within a live performing EPN.

Last, as shown in numeral 106 of FIG. 1, the interface module 201 outputs the selected control values set which is used in the deployment and adaptation of the event processing framework in real time.

The interface module 201 may expose APIs which enable the user to query data about the simulation process and the EPN environment, APIs such as but not limited to:

GetState(X)—retrieves a state of a global or local state variable X.

SimulateEvent(Y)—performs user intervention with the incoming events prediction module automation to simulate a specific event Y.

GetAttributeValue(Z)—queries the value of an attribute Z in the simulation process.

In sequential decision making, numerous decisions are made at different points during the simulation process. Each decision may change the state of the system, and may yield one or more instant values. A decision that yields a positive instant outcome is not necessarily preferable, because its long-term impact over the system may be negative, for any possible sequence of decisions taken from the resulting state and onwards. Therefore, decisions are measured by both their instant outcome and their long term impact on the value-to-go of the resulting state.

In some embodiments, Sequential decision making may be employed, in which the value of the state of the system resulting from a decision is considered. In such a model, each possible decision is evaluated in a context of specific state that can be encountered during the evolution of the system. A sequence of decisions is simulated, and the state values of the system are recorded before and after each of the decisions. In this model, no all possible state-action pairs may be reached, and some of the state action pairs may need to be sampled several times.

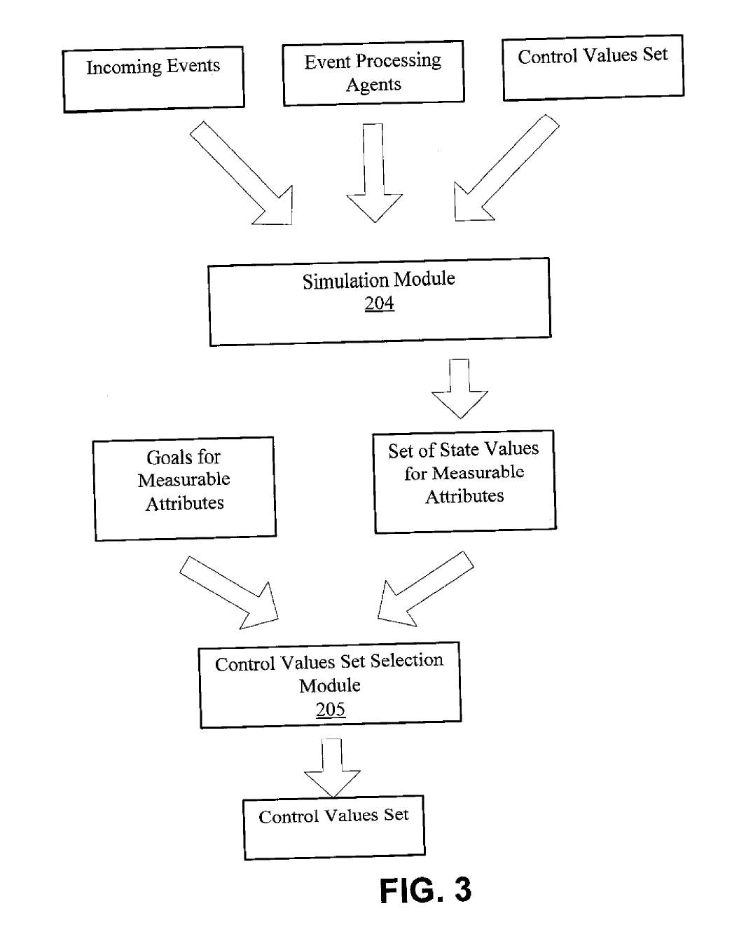

Reference is now made to FIG. 3, which is a diagram illustrating the input and output of an incoming events simulation module 204 and a control values set selection module 205, according to some embodiments of the present invention.

The incoming events simulation module 204 iteratively receives as input incoming events, event processing agents derived from the EPN, and a control values set which determines the behavior of processing rules of event processing agents. In each one of the iterations of the simulation, a different set of possible control values is used by the incoming events simulation module 204. Each iteration produces as an output sets of state values for each of the measurable variables in the EPN according to the provided set of control values.

A plurality of state value sets for measurable attributes and goals for the measurable attributes are provided as input to the control values set selection module 205, which selects a control values set from the provided control value sets. In some embodiments, the control values set selection module 205 attempts to optimize or nearly optimize measurable attributes' values according to the provided goals.

Reference is now made to FIG. 3, which is an exemplary adaptation of an event processing framework of a call center, according to some embodiments of the present invention. In this simplified EPN model of the exemplary call center, three types of incoming events are processed:

Incoming call events—indicating an arrival of a call to the call center. Attributes for an incoming call event may include a unique call index, the date and time of arrival, a customer ID, a problem code, a severity code and/or the like.

Service completion events—indicating service termination for an incoming call. Attributes for a service completion event may include a unique call index, total call duration, assigned agent ID, call completion time, a customer satisfaction score for the specific call, a resolution status code and/or the like.

Agent availability change event—indicating a change in the availability status of an agent capable of handling incoming events. Attributes for an availability change event may include the number of agents available, an identity code of an agent, call handling capacity of an agent and/or the like.

In this simplified EPN model of the exemplary call center, the three types of incoming events are processed by two event processing agents:

Call Routing Agent—associates a call routing event with a specific agent or agent assignee group to be assigned to handle the call, and updates global status variables, for example and without limitation the number of available agents in an assignee group capable of handling incoming events of a certain type.

Resolution Check Agent—matches call arrival events and call completion events which refer to the same incoming call, and updates call statistics according to the resolution time and resolution code. In particular, the call statistics may include attributes such as customer satisfaction or the like.

In this simplified EPN model of an exemplary call center, one or more global states may be defined.

One global state variable may be, for example and without limitation, a global service level agreement (SLA) satisfaction state which may be calculated according to a plurality of customer satisfaction scores for incoming calls. Such an SLA satisfaction state may be calculated according to a plurality of customer satisfaction scores for incoming calls.

In this simplified EPN model of an exemplary call center, one or more constraints may also be defined. For example, one constraint is that the system can only handle up to a constant number of incoming calls simultaneously. This constraint may be indicated by a global state variable “busy server”, and the constraint could be “busy server≦50”.

A possible way of adapting the simplified EPN model of the exemplary call center may target the SLA satisfaction state variable to be maximized, under the constraint that the satisfaction index for each individual call is higher than a specified threshold. The control variables to be selected dictate a call routing policy for each of the different states in the system.

Proactive decision making for the selection of control variables starts with the incoming events prediction module 203 which forecasts future arrivals of incoming calls and service completion events. The user is not required to explicitly state what needs to be forecasted, as prediction is inferred by the system. For example, a forecast of inter-arrival time between calls of substantially similar severity, customer code or a combination thereof may be created by fitting distribution of inter-arrival times of historical events having substantially similar attribute values.

Fitting distribution may be performed by analyzing historical calls which were received during a certain interval, and measuring the time which elapsed between any two subsequent calls. Then, statistical tests may be performed on sample measurements to evaluate their fit with a specific statistical distribution. For example, the statistical distribution may be exponential with specific parameters based on the sample mean and variance values. Similarly, the distribution of other attributes of the forecasted events may be obtained. For example, the severity or urgency of incoming calls may be approximated according to the proportion of specific value occurrences (such as “high”, “medium”, and “low”) in the sample.

Another example of forecasting service duration intervals and/or service completion times may be created by fitting distribution of historical events having an identical issue ID and customer ID. Segmentation choices for prediction may be inferred by the EPN which models the specific call center.

An event processing simulation module 204 for a specific EPN may also be automatically generated by the system, such that the developer is not required to have simulation and/or optimization skills. Automatic generation of the simulation module may be inferred by the definition of the EPN, measurable attributes, control variables, goals, and constraints. Events are generated and injected into the system according to an order set by the incoming events prediction module. In each simulation, time is incremented according to the timestamp of the following incoming event or events.

Upon each call routing derivation, a reinforcement learning algorithm may be employed. For example, a Q-learning method may select a possible value for the assignee group handling the incoming call. A new record is created, which contains global state values of the system before and after deriving the call routing event, the selection of the assignee group and the value of the SLA satisfaction field.

The selection of the value may be aimed towards which maximizing the state-action Q-value for the specific encountered state. Initially, when Q-values estimation is not available, the assignee group selection can be made according to some default value, or arbitrarily. Other methods, such as Monte-Carlo methods, may apply different selection policy, possibly relying on other parameters such as the number of times a certain action was sampled in a certain state, the number of times a certain state was encountered, or the like.

Additionally, constraints are examined for each call routing derivation. For example, verifying the constraint “busy server≦50”. If the constraint is not satisfied, the control value selected for call routing is marked as non-admissible for the global state “busy server” and the derivation is retracted to a previous state. In each such a step, a reinforcement learning algorithm performs calculations according to which future action selections are made. Steps may be iteratively repeated until at least one stopping criterion is met, for example and without limitation when a time threshold is reached. The result of this process is an evaluation of some or all of the possible state-action pairs, possibly dependent on time.

The control values selection module 205 may employ reinforcement learning algorithms to derive a set of control values for each of the control variables which dictate routing policy for each possible global state in the system. The control values selection module may aim to select near optimal control values according to the one or more goals specified for the EPN, and based on the evaluations obtained by the preceding phase.

In general, the invocation of the learning process, resulting in the state-action evaluations, may be based on different policies. For example, periodic invocation or event driven invocation. Exemplary event driven invocations may be relevant every time a routing selection is required in real-time, when a significant change in forecast is detected, or the like.

Embodiments of the systems and methods are natural extensions to existing event processing paradigms, and as such allow quick and simple generation of highly configurable event driven applications with proactive decision making capabilities. Such event driven applications are general (rather than domain specific), and as such allow quick accommodation of EPNs to changes in external event occurrence patterns and volumes.

The methods as described above are used in the fabrication of integrated circuit chips.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems and methods will be developed and the scope of the terms event processing networks and simulations is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method of adapting an event management framework comprising:
providing an event processing network (EPN) which models processing of a plurality of incoming events by said event management framework;
providing at least one goal specifying a target value of at least one measurable attribute of said event management framework;
performing a plurality of simulations of the processing of said plurality of incoming events by said EPN where in each said simulation a set of a plurality of control value sets is simulated on said EPN, each said control value defines a behavioral pattern of at least one event processing agent of said EPN;
selecting a control values set from said plurality of control values sets according to a match between an outcome of said plurality of simulations and said at least one target value; and
adapting said event management framework according to said selected control values set.

2. The computerized method of claim 1, further comprising providing at least one constraint defining a conditional relation within said event management framework, and wherein said selecting a control values set further comprises satisfying said at least one constraint.

3. The computerized method of claim 2, wherein said constraint is a control constraint defining a conditional relation between at least two of said plurality of control variables.

4. The computerized method of claim 2, wherein said constraint is a state constraint defining a conditional relation between at least one of said plurality of control variables and at least one of said plurality of measurable attributes.

5. The computerized method of claim 2, further comprising providing at least one provision indicating when said at least one constraint is to be enforced.

6. The computerized method of claim 1, wherein each said simulation is performed according to a predictive process indicating occurrences of incoming events.

7. The computerized method of claim 6, wherein said predictive process comprises statistical analysis of said plurality of incoming events and provides a forecast indicating future occurrences of incoming events according to event types.

8. The computerized method of claim 7, wherein said statistical analysis of said plurality of incoming events is performed in real time.

9. The computerized method of claim 1, wherein said performing a plurality of simulations further comprises assigning a score to each of said plurality of control value sets according to compatibility of said outcome of said plurality of simulations with said at least one goal, and wherein selecting said control values set comprises consulting with said score.

10. The method of claim 1, wherein said selecting a control values set from said plurality of control values sets employs a Markov decision process for satisfying said at least one goal.

11. The method of claim 1, wherein said selecting a control values set from said plurality of control values sets employs Q-learning methods which estimate values of executing a selected action in a given state of said EPN for satisfying said at least one goal.

12. The method of claim 11, wherein said Q-learning methods are selected from a group consisting of Least-square policy iteration (LSPI) and Monte-Carlo learning.

13. A computer program product for adapting an event management framework, said computer program product comprising:
a computer readable storage medium;
first program instructions to obtain an event processing network (EPN) which models processing of a plurality of incoming events by said event management framework;
second program instructions to obtain at least one goal specifying at least one measurable attribute of said event management framework;
third program instructions to perform a plurality of simulations of the processing of said plurality of incoming events by said EPN where in each said simulation a different set of a plurality of control value sets is simulated on said EPN, each said control value defines a behavioral pattern of at least one event processing agent of said EPN;
fourth program instructions to select a control values set from said plurality of control values sets according to a match between an outcome of said plurality of simulations and said at least one target value;; and
fifth program instructions for adapting said event management framework according to said selected control values set; wherein said first, second, third, fourth and fifth program instructions are stored on said computer readable storage medium.

14. A system for adapting an event management framework, the system comprising:
a processor;
an interface module which receives an event processing network (EPN) which models processing of a plurality of incoming events by said event management framework, at least one goal specifying a target value of at least one measurable attribute of said event management framework, and a plurality of control value sets each comprising at least one control value defining a behavioral pattern of at least one event processing agent of said EPN;
an event processing simulation module which performs a plurality of simulations of the processing of a plurality of incoming events by said EPN where in each said simulation a different set of a plurality of control value sets is simulated on said EPN; and
a control values set selection module which selects a control values set from said plurality of control values sets according a match between an outcome of said plurality of simulations and said target value.

15. The system of claim 14, further comprising an incoming events prediction module which predicts occurrences of said incoming events in said event management framework and provides a forecast indicating future occurrences of said incoming events according to a plurality of event types.

16. The system of claim 15, wherein said incoming events prediction module predicts occurrences of said incoming events in said event management framework according to statistical analysis of said plurality of event types.

17. The system of claim 14, wherein said statistical analysis of said plurality of incoming events is performed in real time.

18. The system of claim 14, wherein said control values set selection module selects said control values set which is Markov-efficient according to a Markov decision process for satisfying said at least one goal.

19. The system of claim 14, wherein said interface module further receives at least one constraint defining a conditional relation within said event management framework, and wherein said control values set selection module selects a control values set which satisfies said at least one constraint.
